(19) United States
(12) Patent Application Publication
(10) Pub. No.: US 2016/0260155 A1
(43) Pub. Date: Sep. 8, 2016

(54) System and Method for Recommending and Dispensing Samples of Wine

(71) Applicant: Gary Landsman, Brooklyn, NY (US)

(72) Inventor: Gary Landsman, Brooklyn, NY (US)

(21) Appl. No.: 15/055,697

(22) Filed: Feb. 29, 2016

Related U.S. Application Data
(60) Provisional application No. 62/126,812, filed on Mar. 2, 2015.

(51) Int. Cl. G06Q 30/06; G06F 17/30

(52) U.S. Cl. CPC G06Q 30/0631; G06F 17/30879

(57) ABSTRACT

A system and method for recommending and dispensing wine samples at a retail establishment based on a user's taste profile. The system and method employs the use of a proprietary mobile application in connection with an interactive user-experience within a retail environment. The mobile app uses a combination of methods to narrow or recommend the type of wine a user should be sampling in order to determine the optimal choice, based on taste, for each particular consumer. The user can use the mobile app to earn points by performing various wine-related tasks and redeeming said points for wine samples which can be automatically dispensed from automated wine dispensers via user interaction with the mobile app within the retail store. This system and method allows consumers to taste or sample a particular bottle of wine to determine whether or not the wine is to his/her liking before purchasing said bottle.

### RELATED APPLICATIONS

This application is a non-provisional of and claims priority to U.S. Provisional Patent Application No. 62/126,812, filed on Mar. 2, 2015, a copy of which is incorporated herein by reference.

### FIELD OF THE DISCLOSED TECHNOLOGY

The present application is generally in the field of wine tasting, and more specifically to the use of a mobile application in combination with a retail store experience to help consumer's find and sample wines which are suitable to his/her taste.

### BACKGROUND OF THE DISCLOSED TECHNOLOGY

Wine selection can be a very overwhelming and intimidating process. Consumers who are not educated or knowledgeable in this area often resort to visiting a retail establishment and asking the store employees or attendants for recommendations. Many of these retail establishments stock an enormous array of items (several hundred or even thousands) making it difficult to narrow the selection down to a specific type, year, region and brand. This is also a very costly gamble for consumers as wine is stocked in closed bottles forcing consumers to purchase an entire bottle, which may not ultimately be to his or her liking.

Recently, software and mobile applications have been developed to assist consumers with finding and recommending a particular wine based on algorithms which use consumer wine ratings and ratings of similar users to predict or to recommend a wine which is likely to be to a user's liking. These algorithms are refined as the user enters more and more ratings over time using machine learning. However, this method continues to pose a problem for new or inexperienced wine drinkers who have rated an insufficient number of wines, if any, to form the basis for meaningful machine learning. Therefore, these inexperienced wine drinkers get no guidance from these applications regarding where to begin tasting and cannot even begin to build a wine tasting profile without taking a hit-or-miss approach by purchasing several bottles and rating them to establish a taste profile for the user. The risk that a consumer will not like a particular bottle is significantly large in the beginning and requires the purchase of several bottles of wine, which can sometimes be quite expensive, to determine whether or not the wine is to his or her liking.

The disclosed technology seeks to overcome the deficiencies in the existing wine recommendation technology by providing a proprietary mobile app which may work in the context of a retail wine establishment and provide interaction between the mobile app and automated wine sampling dispensers.

### SUMMARY OF THE DISCLOSED TECHNOLOGY

In one aspect of the disclosed technology, a method includes the steps of receiving from a mobile device, a request for a sample of an unspecified wine from among a plurality of wines stored in a plurality of wine dispensers, each of said wine dispensers containing at least one wine selection. Responsive to the request, a processor determines a specific wine, said determining based at least on data accessible by the processor and responsive to the request and the determining, dispensing a sample of the specific wine.

In another aspect of the disclosed technology, a system for providing wine samples includes a retail establishment having a plurality of automated wine dispensers contained therein, each of the plurality of wine dispensers having at least one wine selection contained therein; a mobile app stored on a mobile device, the mobile app operative to initiate a request to receive a sample of an unspecified wine from one of the plurality of automated wine dispensers; and a processor operative to determine, in response to the request, a specific wine, based at least on data accessible by the processor.

In another aspect of the disclosed technology, a method for creating a wine recommendation list includes the steps of receiving a scan or photo of at least a portion of a human tongue, analyzing the scan or photo to determine the number of taste buds within a predetermined area of the human tongue, and determining at least one wine recommendation based at least on the density of taste buds within the predetermined area.

### DESCRIPTION OF THE DRAWINGS

FIG. 1 is a sign-in/sign-up screen from a mobile app.

FIG. 2 is a user account sign up screen from a mobile app.

FIG. 3 is an option (explore or taste) screen from a mobile app.

FIG. 4 is a sample popular wine recommendation list screen from a mobile app.

FIG. 5 is a screen from a mobile app asking a user to take a taste test.

FIG. 6 is a taste test question screen from a mobile app.

FIG. 7 is a taste test question screen from a mobile app.

FIG. 8 is a taste test question screen from a mobile app.

FIG. 9 is a taste test question screen from a mobile app.

FIG. 10 is a taste test question screen from a mobile app.

FIG. 11 is a taste test question screen from a mobile app.

FIG. 12 is a taste type results screen from a mobile app.

FIG. 13 is a secondary question screen from a mobile app.

FIG. 14 is a secondary question screen from a mobile app.

FIG. 15 is a secondary question screen from a mobile app.

FIG. 16 is a secondary question screen from a mobile app.

FIG. 17 is a secondary question screen from a mobile app.

FIG. 18 is a secondary question screen from a mobile app.

FIG. 19 is a secondary question screen from a mobile app.

FIG. 20 is a secondary question screen from a mobile app.

FIG. 21 is a sample personal wine recommendation list screen from a mobile app.

FIG. 22 is a wine list filter screen from a mobile app.

FIG. 23 is a wine description screen from a mobile app.

FIG. 24 is a wine information screen from a mobile app.

FIG. 25 is a main menu screen from a mobile app.

FIG. 26 is a user profile screen from a mobile app.

FIG. 27 is a scan screen from a mobile app.

FIG. 28 is a wine location screen from a mobile app.

FIG. 29 is a warning screen from a mobile app.

FIG. 30 is a system data flow chart.

FIG. 31 is a user request and wine dispensing process flow chart.

### DETAILED DESCRIPTION OF PREFERRED AND ALTERNATE EMBODIMENTS

The disclosed technology is directed to a system and method for recommending and dispensing wine samples at a retail establishment based on a user's taste profile. The system and method employs the use of a proprietary mobile application (also referred to interchangeably herein as “the app”, “mobile app” or “app”) in connection with an interactive user-experience within a retail environment. The app uses a combination of methods to narrow or recommend the type of wine a user should be sampling, including in one embodiment, in order to determine the optimal choice, based on taste, for each particular consumer. The user can use the mobile app to earn points by performing various wine-related tasks, including but not limited to: creating a user account; engaging in a taste test which includes answering a first series of questions; answering a second series of taste-related questions; rating a wine the user has tasted; reviewing a wine the user has tasted; referring a new person to sign up for an account; and sharing a rating, review, photo or other information regarding a bottle of wine on a social media website such as Facebook, Twitter, Instagram, Pinterest, Google+, or other such social media site. Accumulated points can be redeemed for wine samples which can be automatically dispensed from automated wine dispensers (also referred to herein interchangeably as “wine dispensers” and “dispensers”) via user interaction with the mobile app within the retail store. This method allows consumers to taste or sample a particular bottle of wine to determine whether or not the wine is to his/her liking before purchasing said bottle.

Unless otherwise defined, all terms used herein have the same meaning as commonly understood by one having ordinary skill in the art to which this technology applies. The examples set forth herein are intended to describe a preferred embodiment only and are not intended to limit the claimed invention in any way.

The term “software” or “computer program” as used herein, includes but is not limited to: one or more machine readable and/or executable instructions that cause a computer, microprocessor, logic circuit, or other electronic device to perform functions, actions and/or behave in a desired manner. The instructions may be embodied in various forms such as routines, algorithms, modules or programs including separate applications or code from dynamically linked libraries. Software may also be implemented in various forms such as a stand-alone program, an app, a function call, a servlet, an applet, instructions stored in memory or any other computer readable medium, part of an operating system or other type of executable instructions. It will be appreciated by one of ordinary skill in the art that the form of software is dependent on, for example, requirements of a desired application, the environment it runs on, and/or the desires of a designer, programmer or the like.

“Mobile device” as used herein, is a small computing device including but not limited to: a smartphone; a tablet computer; a personal data assistant (PDA); a gaming device; a laptop computer; and wearable technologies.

“Mobile Application”, “Mobile App”, or “App”, as used herein, includes but is not limited to: applications that run on smart phones, tablet computers and other mobile devices. The terms “mobile application”, “mobile app” and “app” can be used synonymously with “software”. Mobile applications allow users to connect to services which are traditionally available on a desktop or notebook platforms. Typically, these services access the internet or intranet or cellular or wireless fidelity networks to access, retrieve, transmit and share data.

The term “computer”, “processor” or “processing unit” as used herein, includes but is not limited to: any programmed or programmable electronic device, microprocessor or logic unit that can store, retrieve and/or process data.

The term “network” as used herein, includes but is not limited to: a collection of hardware components and computer or machines interconnected by communications channels that allow sharing of resources and information, including without limitation, the world wide web or the internet.

The term “web browser” as used herein, includes but is not limited to: a software for retrieving and presenting information resources on the world wide web. An information resource may be a web page, an image, a video, or any other type of electronic content.

The term “server” as used herein, includes but is not limited to: a computer or machine or a device on a network that manages network resources. The general term “server” may include specific types of servers, such as a file server (a computer and storage device dedicated to storing files), a print server (a computer that manages one or more printers), a network server (a computer that manages network traffic), and a database server (a computer system that processes database queries). Although servers are frequently dedicated to performing only server tasks, certain multiprocessing operating systems allow a server to manage other non-server related resources.

A “web server” as used herein, includes but is not limited to: a server which serves content to a web browser by loading a file from a disk and serving it across a network to a user's web browser, typically using hyper-text transfer protocol (HTTP).

The term “cloud” as used herein, includes but is not limited to: a service or services for compute resources including Infrastructure-as-a-Service (IAAS), Platform-as-a-Service (PAAS), Software-as-a-Service (SAAS) and other forms of hosted compute resources. Said resources replacing or supplementing traditional servers, networks, storage and processors as well as providing aggregate services not available on traditional compute resources.

The term “cloud application” as used herein includes but is not limited to: a computer program or software implemented on cloud services, including but not limited to IAAS, PAAS and SAAS.

“Application Programming Interface”, “API Files” and “API” as used herein, includes but is not limited to: an interface between different software programs or software files which facilitate the interaction between different software programs or software files by way of a specific set of rules and specifications.

The term “web sockets”, as used herein, is an API that makes it possible to open an interactive communication session between a web browser and a server wherein messages can be sent to a server and receive event driven responses without having to poll the server for a reply.

### The Retail Environment

The retail store contains a plurality of bottles of wine for sale. The store also contains a plurality of wine dispensers which interact with a mobile app to dispense wine samples to consumers under certain conditions. Store consultants are also available to assist consumers who are unable or unwilling to use his or her own mobile device to obtain a wine sample or who are unwilling or unable to sign in to the app or to sign up for a user account. The store may keep one or more mobile devices on hand for such situations and store consultants may assist a consumer in using an in-store mobile app to facilitate wine tasting. Store consultants are also on hand to answer any questions and offer personal assistance and recommendations for both users using the app in-store and for those who opt to forego to the retail store/mobile app experience. The store may have its entire inventory available for sampling or it may have less than the entire inventory, such as only the most popular wines, available for sampling. The store may also have samples of wines not carried in regular inventory.

The mobile app (described in further detail below) provides an interactive user experience for users visiting the retail store. The users may browse the store while looking up specific information regarding wines he or she is interested in tasting and/or purchasing. Users may participate, via the mobile app, in answering one or more series of questions intended to narrow his or her search for wines that are more likely to be to his or her liking. This option is especially useful for new users or users who are not particularly wine savvy. The app also provides filtering options which are useful to both new and experienced wine drinkers who quickly want to find a specific wine or a wine at a specific price point, a specific color, a specific taste, of a specific varietal, to pair with a particular menu, or to simply view the most popular wines. The app also provides users with the ability to browse, taste and shop independently without significant interaction with store consultants, if desired. The automatic wine dispenser tie-in with the mobile app also provides a fun interactive user experience. The app is able to direct the user to the exact location within the store of any wine of interest to the user. It also allows the user to automatically dispense his/her own wine sample, given he/she meets the predetermined criteria (discussed in further detail below) with minimal assistance from store consultants (only verifying age). On the other hand, users may want to browse wines or narrow their options using the mobile app but may wish to further inquire about the various wines with store consultants.

### Automated Wine Dispensers

Each of the plurality of wine dispensers contain software which works in combination with the hardware to control the mechanical and electronical components thereof. In a preferred embodiment, the dispensers are in networked communication with one or more physical devices and/or software applications. In a preferred embodiment, each of the plurality of wine dispensers contain two (2) different wines available for sample. In other embodiments, each dispenser may contain only one (1) wine selection therein or may contain greater than two (2) different wine selections therein. Each wine available for sampling has a predetermined point value assigned thereto. Point values are assigned based on the price of the bottle of wine on a dollar to point basis, although other point assigning schemes may be used. For example, a bottle of wine costing $10 is assigned a point value of 10 and a bottle of wine costing $20 is assigned a point value of 20. In order to sample a selected wine, a user must have accumulated points equal to or greater than the point value assigned to the selected wine. Each of the plurality of dispensers also contain a unique machine readable identifier attached thereto. In a preferred embodiment, the identifier is a Quick Response (QR) code, however, the identifier may alternatively be a two- or three-dimensional bar code, a digital watermark, Near Field Communication (NFC) chip or tag, or any other machine readable identifier capable of being read and/or interpreted by a mobile device. In a preferred embodiment, a machine readable identifier may contain data or information that uniquely identifies each dispenser and the specific retail store in which the dispenser is located. In other embodiments, the machine readable identifier may include information or references which include, but are not limited to: the exact location within the retail store where the dispenser is located, the rack or slot number indicating where the dispenser is located, the type of wine or wines contained within the dispenser, and the point value assigned to each of the wines contained within the dispenser. All dispensers are in a “locked” mode until “unlocked” by user interaction with the mobile app. Push buttons may be located on each dispenser and are used to initiate the actual dispensing of the wine sample from the dispenser once is has been “unlocked” via a request from the mobile app. Pressing a push button prior to “unlocking” the dispenser via the mobile app has no effect on the dispenser and will not initiate the dispensing of a sample. Using the mobile app, the user may scan the QR code on the dispenser containing the wine selected by the user for sampling. Information obtained from the QR code is used to in part to determine whether or not a certain set of predetermined criteria have been met to allow dispensing of the sample. The predetermined criteria may include, but are not limited to: whether or not the user has accumulated enough points for the requested sample (user's total points must be greater than or equal to the number of points required for the sample); and whether or not the user has used all of his/her allotted samples for the visit or for the day (number of samples used for the visit (or day) must be less than the maximum number of allotted samples for the visit (or day), which in the preferred embodiment is six (6)). The user must also be old enough to legally receive the sample. If the pre-determined criteria are met, then the dispenser is “unlocked”. Once the dispenser is “unlocked” the user can push the press button on the dispenser and the dispenser will automatically dispense the wine sample. The sample, in a preferred embodiment, is generally between ½ and 1 fluid ounce, although other sample sizes may be used. Once the sample is dispensed, the user's account is debited by the number of points required for the sample and the dispenser returns to the “locked” state.

Information about each of the plurality of wine dispensers, such as, for example, location and contents, may be stored in a database or other data store, located on either a local or remote server.

While the plurality of wine dispensers is described herein as having a QR code attached thereto, other machine readable identifiers may be used. The type of data and the subject of the data stored on the QR code may also be modified while remaining within the scope of the disclosed technology. The push button on each of the plurality of wine dispensers can be replaced by a touch screen, a lever, a pull tab or any other electrical, mechanical or electromechanical actuator. Also, the predetermined criteria used to determine whether or not a sample should be dispensed from the dispenser can be based on an entirely different set of rules or requirements.

### The Mobile App

The mobile app of the present disclosure and related technology provides consumers with an interactive experience within a retail environment. Users may download the mobile app to a mobile device. In a preferred embodiment, the mobile device includes, but is not limited to: a processor; programming instructions; tangible computer-readable memory; a display, preferably a touch-screen display; and a user interface including means for user input such as a keypad, microphone and camera. The electronic device may be in communication with one or more physical devices and software applications which may in turn communicate with one or more databases and memory on which is stored computer executable code or logic and one or more computer algorithms. The one or more databases may create, read, update and delete data used by the mobile app or other networked device. The one or more databases and memory can be stored externally, such as on a cloud platform. The mobile app may be downloaded to the mobile device from the Apple App Store, Google Play Marketplace, Chrome Web Store, or any other online marketplace. Alternatively, the app may be downloaded to a mobile device by non-marketplace means such as Mobile Device Management (MDM) software.

The mobile app may provide the user with the ability to create a user account, engage in a taste test to determine the user's taste type, receive and browse a list of recommended wines based on the user's assigned taste type, browse a list of popular recommended wines, learn about the plurality of wines available for purchase, earn points for performing various activities (discussed in further detail below), redeem said points for wine samples by using the mobile app to communicate with wine dispenser located in the retail store, post ratings or reviews of sampled wine, purchase one or more bottles of wine, add one or more bottles of wine to a wish list, share information about one or more bottles of wine via a social media web site, and perform other wine-related tasks or activities. Specific features of an embodiment the mobile app are discussed in greater detail below.

In addition to the mobile app, a website for the retail store may be available for viewing by users via a web browser. The website may contain a list of all wines available for purchase and provide users the ability to purchase one or more bottles of wine online and have said bottles shipped, delivered (if delivery is within a certain predetermined radius of the retail store), or picked up in-store.

### Setting Up a User Account

Upon entering the retail store the user may be encouraged to either download and/or open the mobile app on his or her mobile device. A returning visitor may have already downloaded the app or a new user may have downloaded the app prior to visiting the retail store.

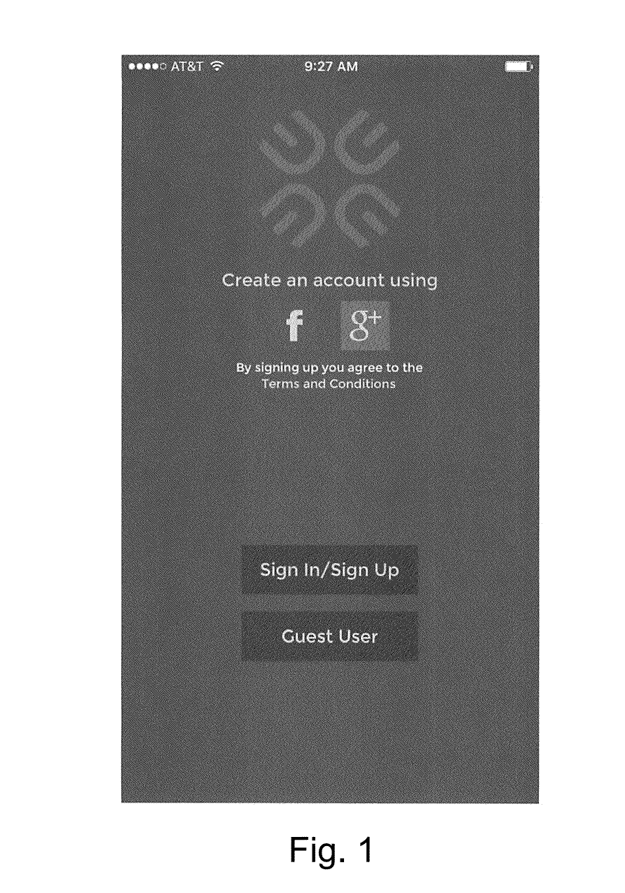

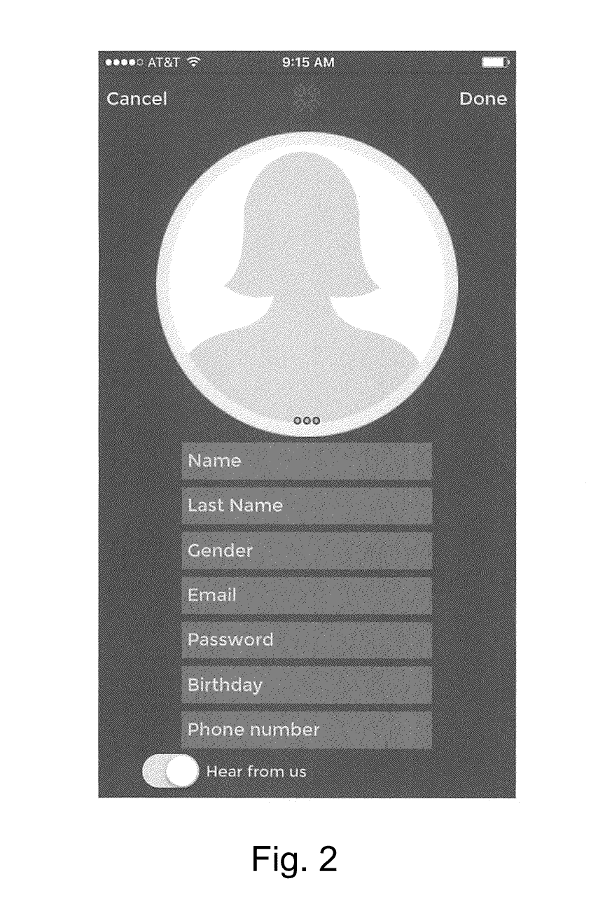

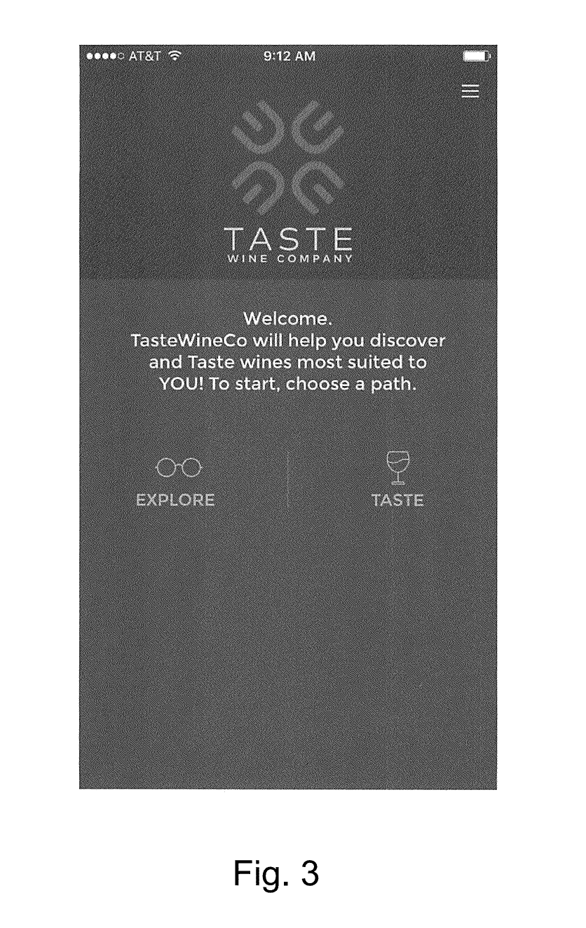

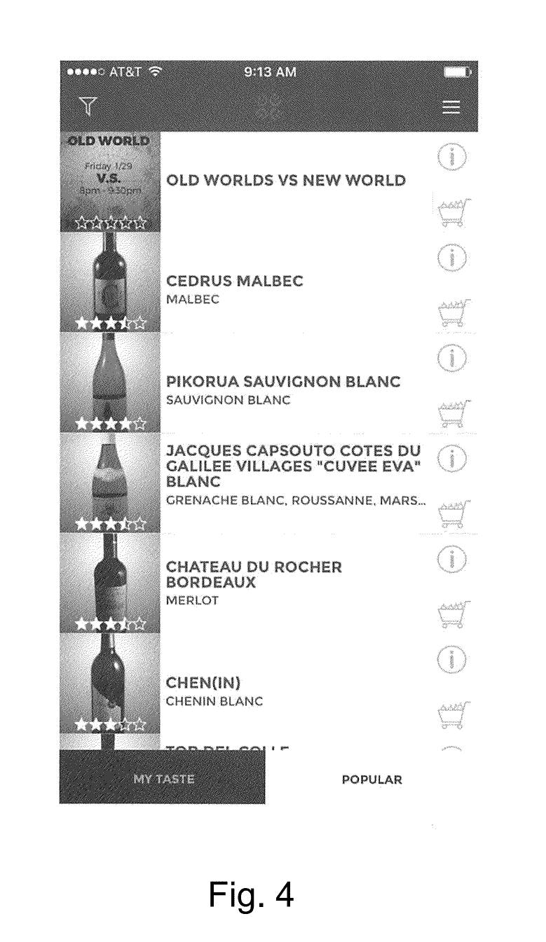

An example of an initial screen of the mobile app, shown in FIG. 1, prompts existing users to sign in to his or her account and prompts new users to sign up for a new account but also allows users to use the app as a guest user. A new user may create an account by signing in using a pre-existing identity management system such as Facebook or Google+account or by filling out a form providing the user's name, gender, email address, password, birthday and phone number, as shown in FIG. 2. The user can also select whether or not he or she wishes to receive future marketing materials via email. Alternatively, users may bypass setting up a user account by opting to be a guest user. As a guest user, the user may be unable to be assigned a taste type and may be unable to use the mobile app to taste any of the available wine samples. A guest user may only use the app to learn about the various wines available for purchase. Guest users may be offered the option of exploring a popular wine recommendation list, as shown in FIGS. 3 and 4. If a user is unable or unwilling to use his/her mobile device to earn point and redeem said points for one or more wine samples, mobile devices may be available for consumer use in-store.

### Earning Points

Users of the mobile app may be awarded points for performing various wine-related activities or tasks. Such tasks may include, but are not limited to (including point values which may be awarded for performing each task in the preferred embodiment): creating a user account (100 points); engaging in a taste test which includes answering a first series of questions (20 points); answering a second series of questions (20 points); rate a wine the user has tasted (10 points); review a wine the user has tasted (20 points); refer a new person to sign up for an account (30 points); and sharing a rating, review, photo or other information regarding a bottle of wine on a social media website such as Facebook, Twitter, Instagram, Pinterest, Google+, or other such website (30 points). While these point values have been disclosed as part of a preferred embodiment, other point values may be assigned to each task (or other tasks). Other tasks for which points may be rewarded include, but are not limited to: adding one (1) or more bottles of wine to the user's wish list; adding one (1) or more bottles of wine to the user's shopping cart; granting permission to receive marketing emails via email or text message; sharing a friend's email address; and purchasing a certain number of bottles of wine during a certain period of time. Additional activities or tasks may replace or be added in addition to those described above. Points may be redeemed for wine samples. As noted above, each wine available for sample may have a point value assigned thereto based on the cost of a bottle of that particular wine. Users must have enough points to sample a particular selection. Information such as the point values associated with each point-earning activity, and a user's running point balance may be stored in a database or other data store on a local or remote server.

### Determining a Taste Type

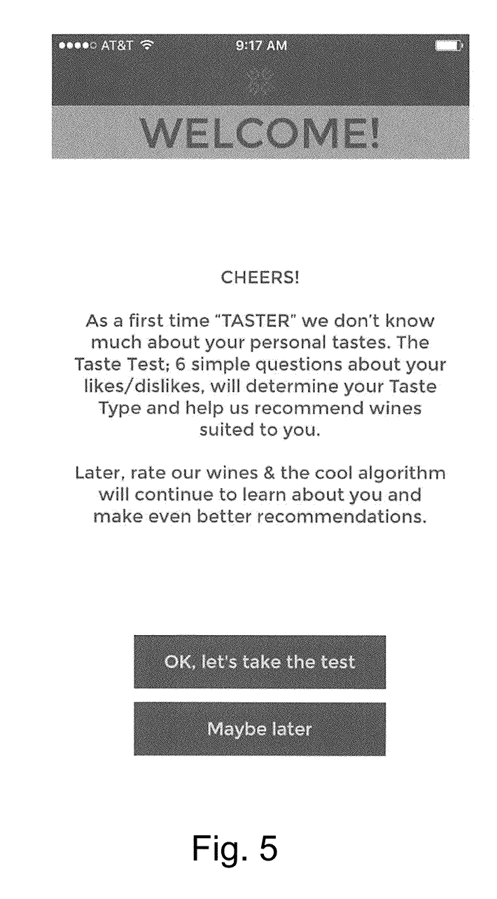

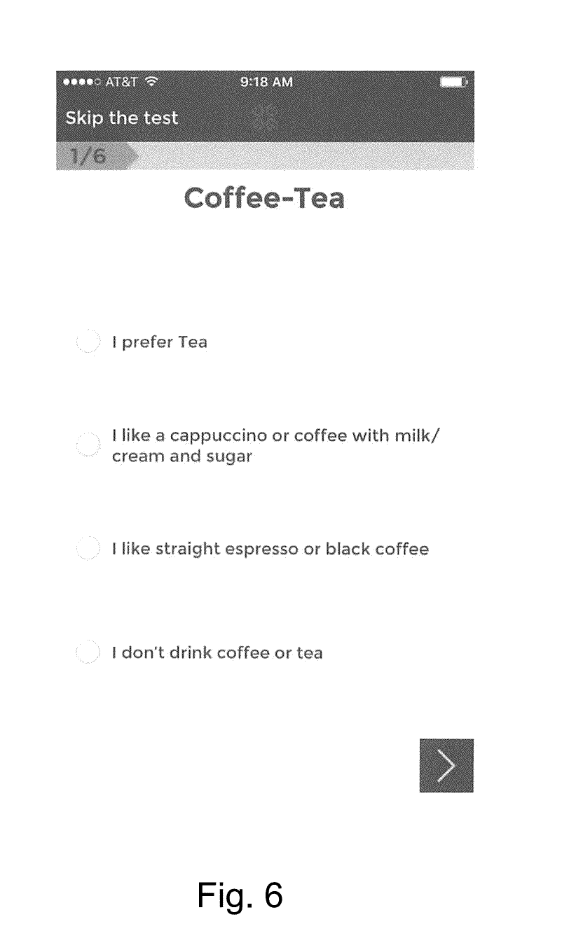

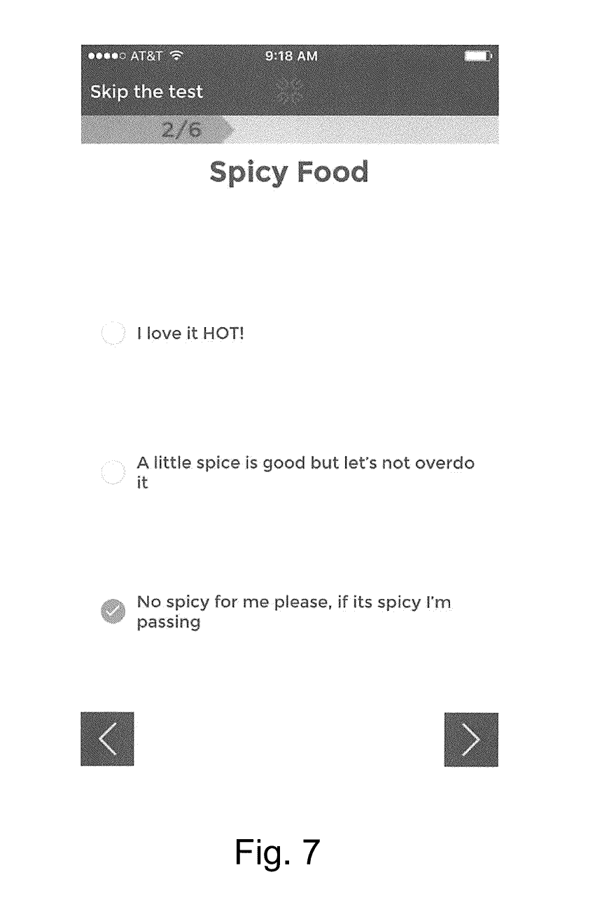

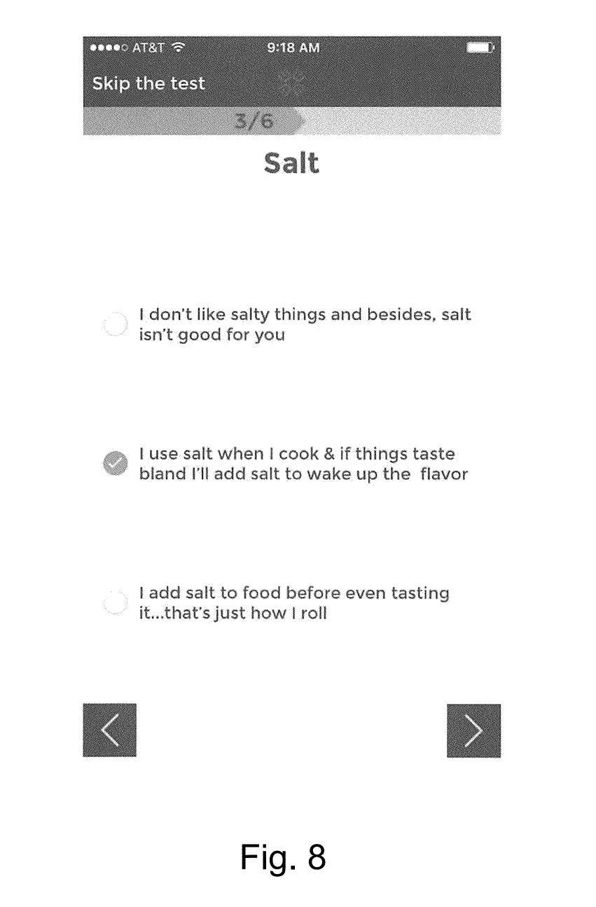

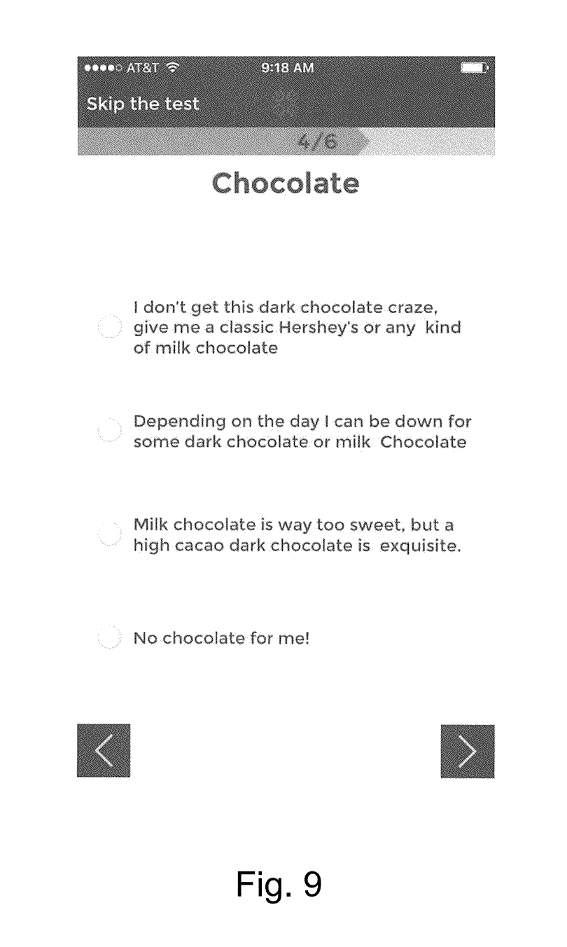

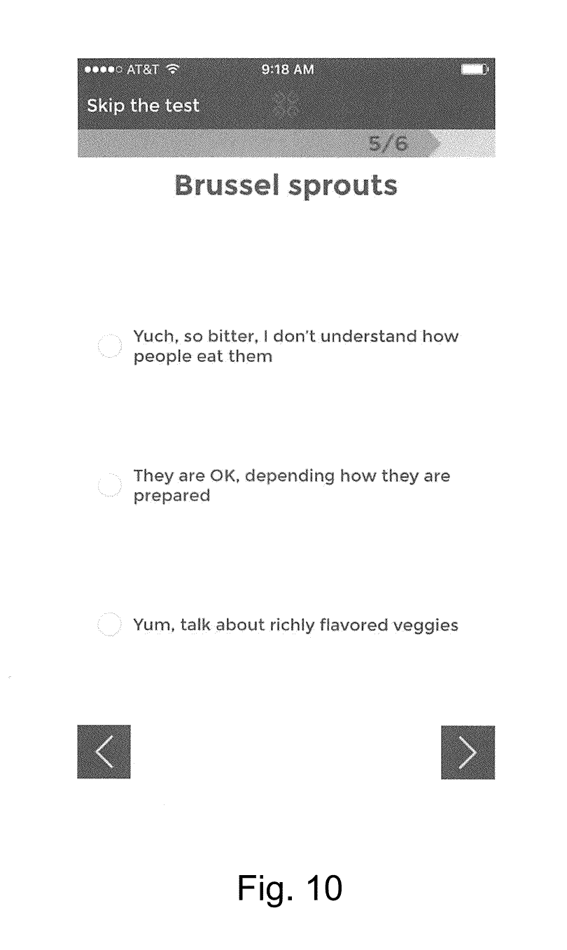

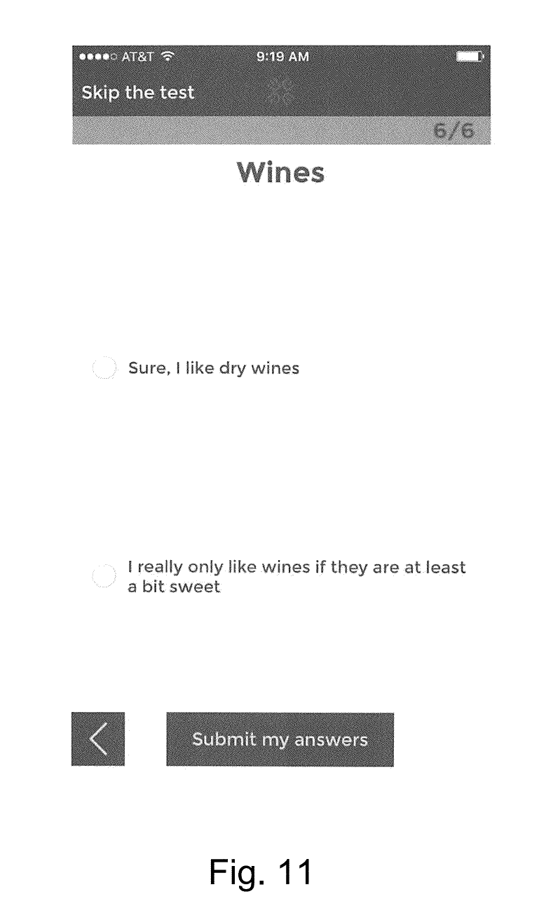

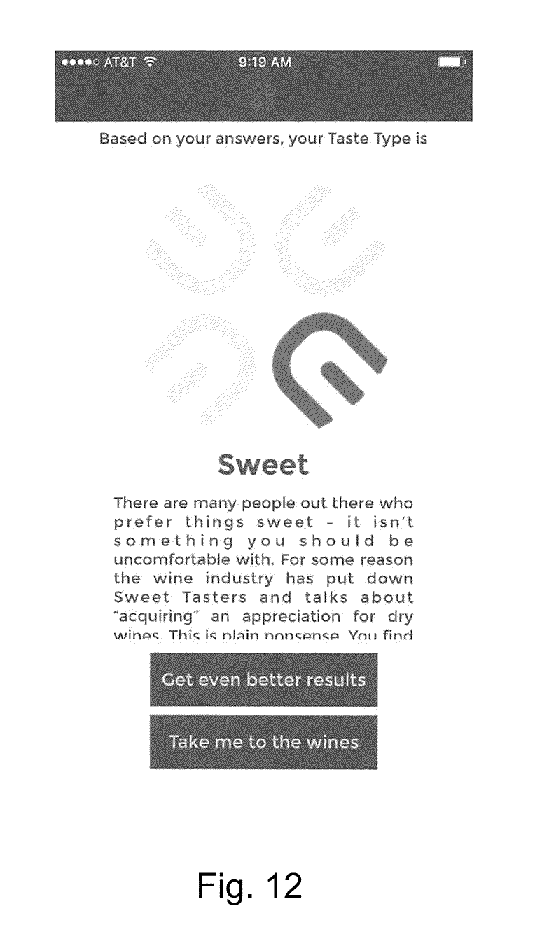

Once a new user has signed up for a new user account, the app may prompt the user to take a taste test (as shown in FIG. 5) which, in a preferred embodiment, may include six (6) questions posed to the user about his or her likes and dislikes, as shown in FIGS. 6 through 11. In other embodiments, the number of questions in the taste test may be less than six (6), seven (7), eight (8), nine (9) or ten (10) or greater and may be directed to other subject matter. The user-supplied answers to these questions may be input into an algorithm operative to determine the user's taste type. Determining a taste type allows the app to provide the user with a list of recommended wines which he or she would be more likely to enjoy. In a preferred embodiment, the taste type can be any one of the following: sweet, hyper, balanced, or bold. An example of a screen reporting the user taste type based on his or her answers to the taste test is shown in FIG. 12. However, in other embodiments, additional taste types may be included. The user must answer the first series of questions to be assigned a taste type and to receive a personal wine recommendation list. If the user chooses not to take the taste test, he or she may not be assigned a taste type and may only be offered the option to either browse a popular wine recommendation list or to begin sampling wines (provided he or she has signed up for a user account).

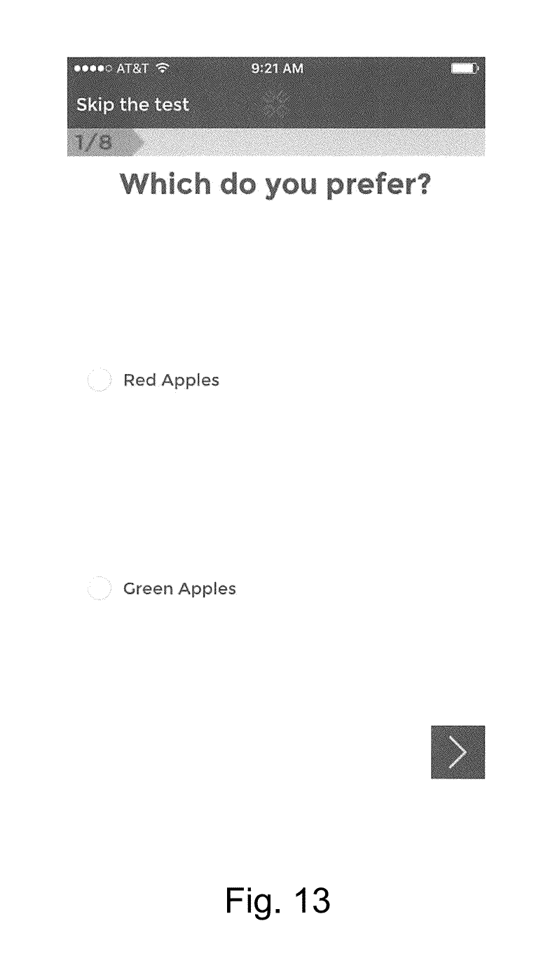

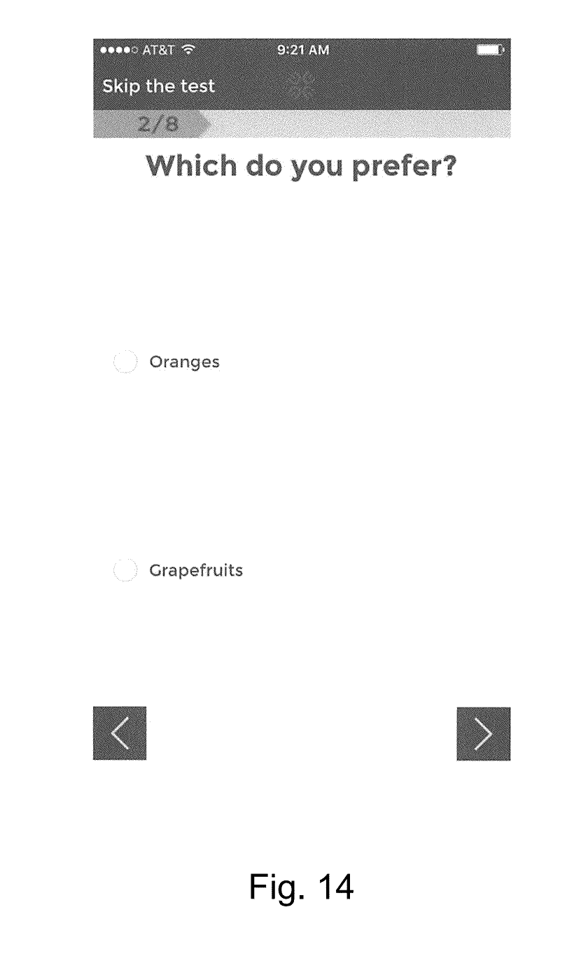

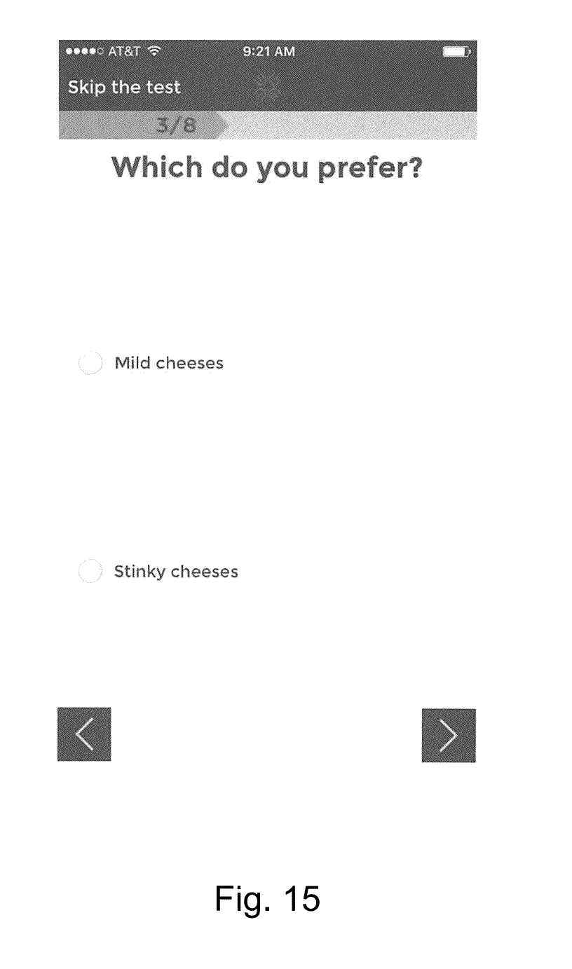

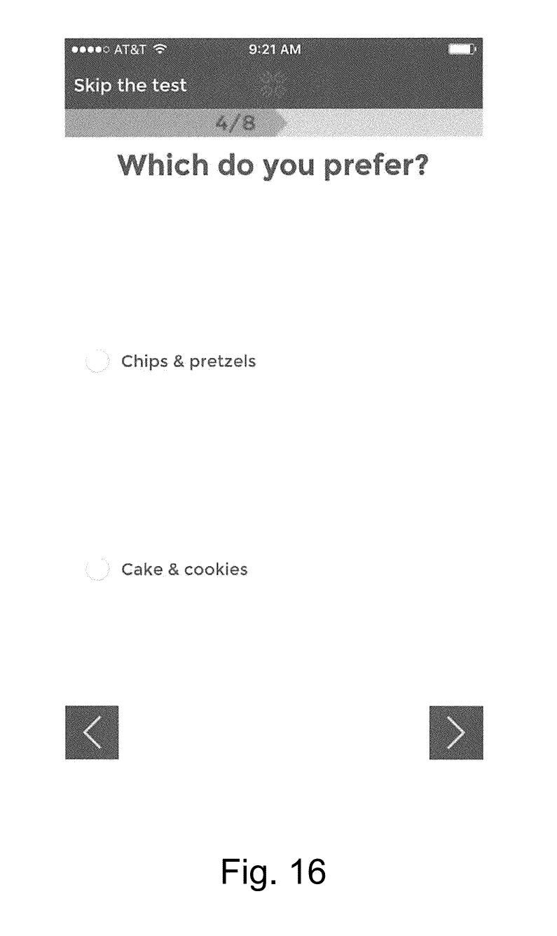

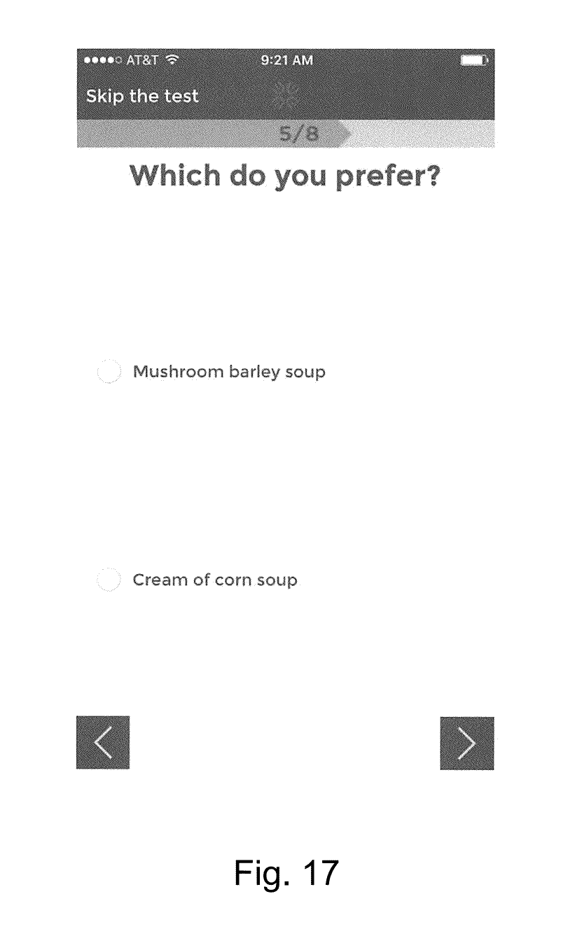

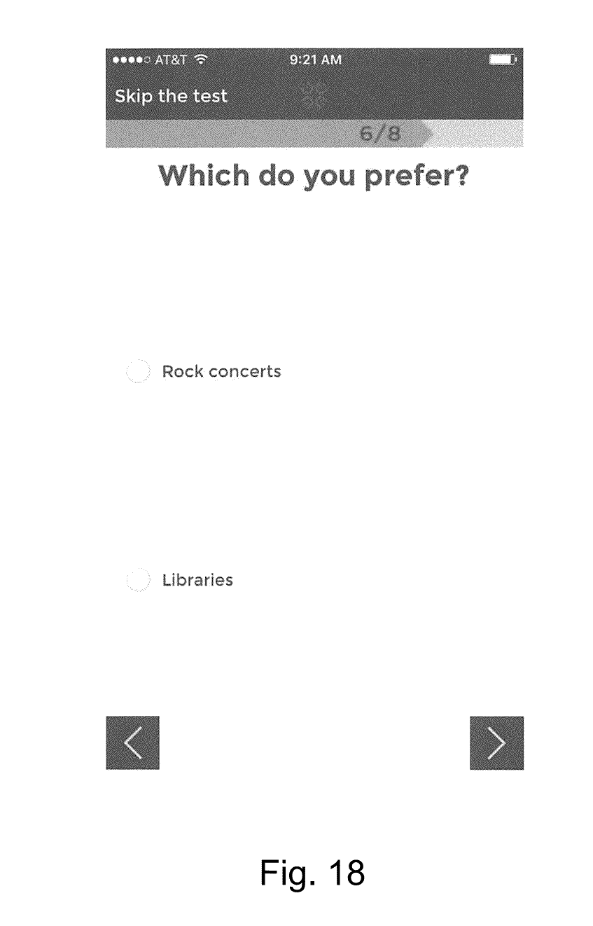

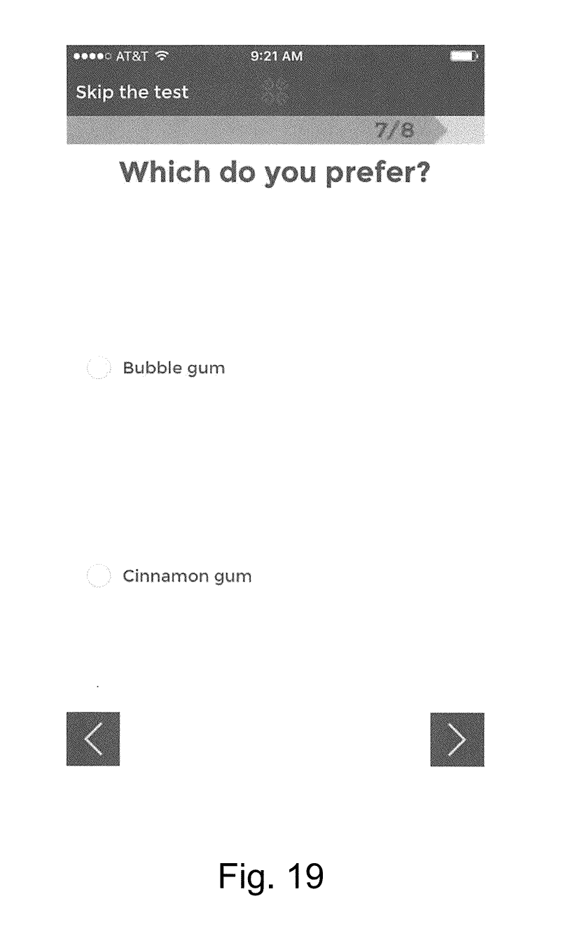

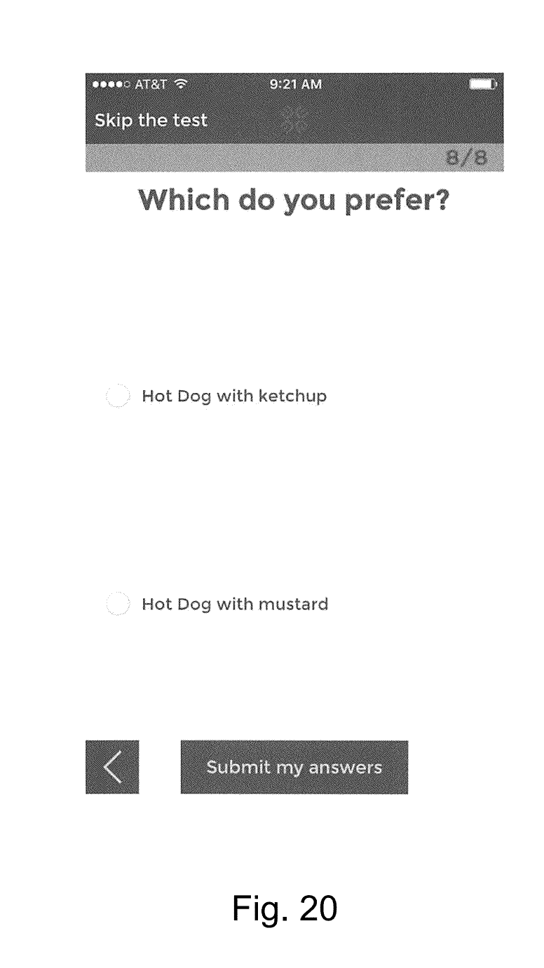

If the user does take the taste test and is assigned a taste type, the app may invite the user to answer a second series of questions to further refine the user's personal wine recommendation list, also shown in FIG. 12. In a preferred embodiment, the second series of questions may comprise eight (8) multiple choice questions in the form of “which do you prefer?” which inquire about the user's personal taste preferences for food and drink items including, but not limited to: coffee; salty and spicy foods; chocolate; vegetables; fruit and wine, as shown in FIGS. 13 through 20. In other embodiments, the number of questions may be five (5) or less, six (6), seven (7), nine (9), or ten (10) or greater and the questions may be directed to other food and drink preferences or other subject matter. These questions are intended to more closely predict a selection of wines which the user will find enjoyable. The second series of questions may be entirely optional. If the user chooses to answer the second optional set of questions, the app may guide them through the questions and if the user decides not to answer the second set of questions, the app may offer him or her the option to browse his or her personal (or popular) wine recommendation list or to begin tasting.

As noted above, in alternate embodiments, the taste test and subsequent series of optional questions may include a different number of questions that may be directed to different content as long as said questions are aimed at determining a specific taste type or one or more tasting characteristics of the user or which can be used to further refine his or her personal wine recommendation list. Also, in other embodiments, the process may only include the taste test and omit the second series of questions.

In an alternate embodiment, instead of or in addition to using the user's answers from the taste test, the user's taste type may be determined or further refined by analyzing the density of a user's taste buds or papillae. The number of taste buds on a user's tongue can vary greatly from as many as 1,100 per square centimeter to as little as 11 taste buds per square centimeter. In this embodiment, the mobile app is operative to take a picture or scan of at least a portion of a user's tongue, send the picture or scan to the central application where the scan or photo can be analyzed to determine the number of taste buds within a certain pre-determined area of the user's tongue. Based on this information, certain inferences can be made about the types of food and drink a user may be particularly sensitive to. For example, a higher density of taste buds correlates to tasters being especially sensitive to bitter tastes. This information is then used either in place of or in addition to the taste test results to determine a user's taste type and to determine a list of wines that are more likely to appeal to the user.

### Wine Recommendation Lists

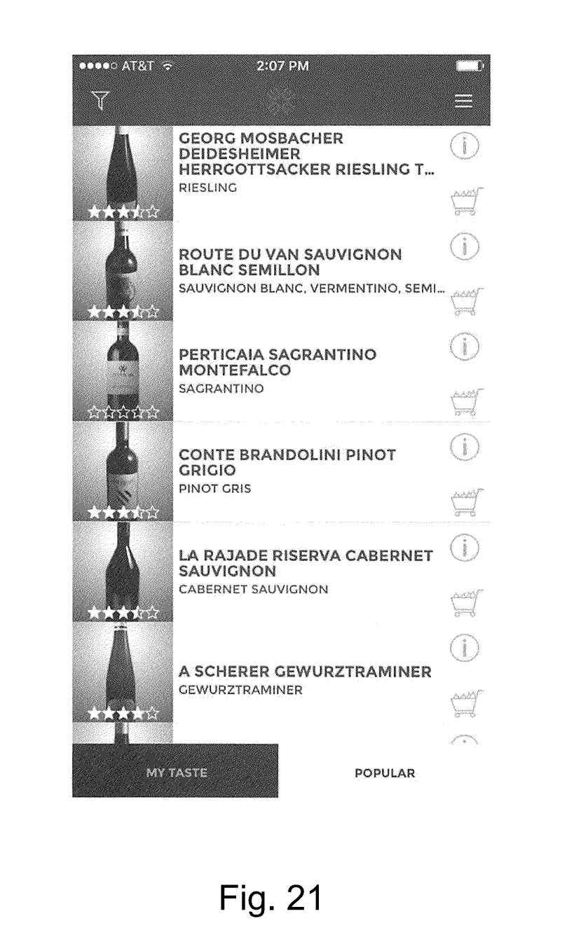

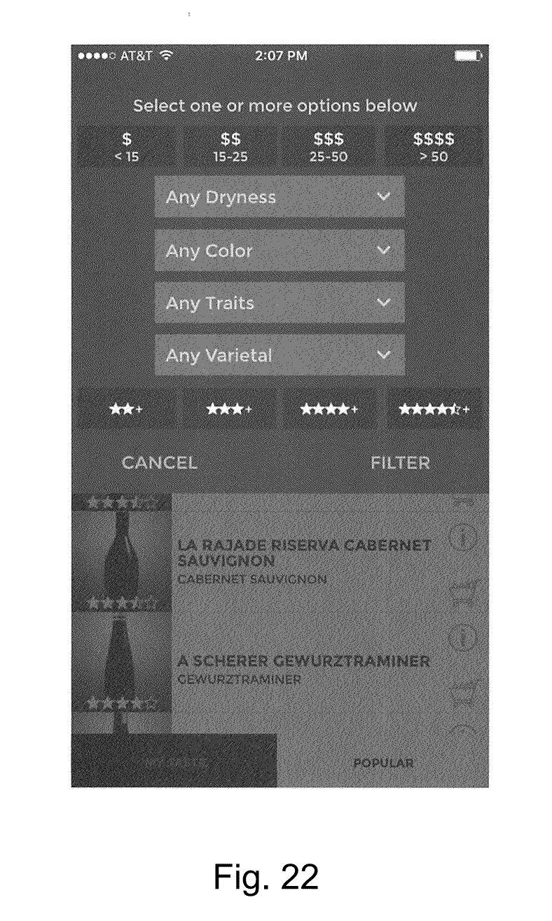

Determining a user's taste type is necessary for the creation of a personal wine recommendation list based on the user's assigned taste type. The personal recommendation list includes wines which are compatible with the user's taste type and which the user may be more likely to enjoy. An example of a personal wine recommendation list as provided by the mobile app is shown in FIG. 21. The app may also provide users with a recommendation list based on popular wines. Users who have been assigned a taste type (by taking the taste test) may have access to both a personal wine recommendation list (based on his or her taste type) and a popular wine recommendation lists. Users who do not receive a taste type (because they did not sign up for an account and/or did not take the taste test) may only have access to the popular wine recommendation list. The popular wine recommendation list may be composed based on store sales, user ratings and/or reviews, overall industry trends, or other such criteria. Each wine list (personal or popular) gives the user the option to filter the list based on various features, as shown in FIG. 22. In a preferred embodiment, these features may include, but are not limited to: cost (less than $15, between $15-$25, between $25-$50, or greater than $50); dryness (any dryness, dry or sweet); color (red, rose or white); traits (various based on color); varietal (various); or user ratings (two (2) or more stars, three (3) or more stars, four (4) or more stars, or five (5) or more stars). Other potential filtering options may include, but are not limited to: vintage (year of harvest); country of origin; food options the wine may pair well with; and number of ratings or reviews. The wine traits may be filtered based on the color of the wine. For example, for red wine, the traits may include, but are not limited to: sweet, light & fruity, bold & rich, smooth & elegant, and spicy. For rose, the traits may include, but are not limited to: bubbly. And for white wine, the traits may include, but are not limited to: sweet, smooth & silky, rich & creamy; and tart and fresh. Similarly, the varietals can also be filtered based on the color of the wine.

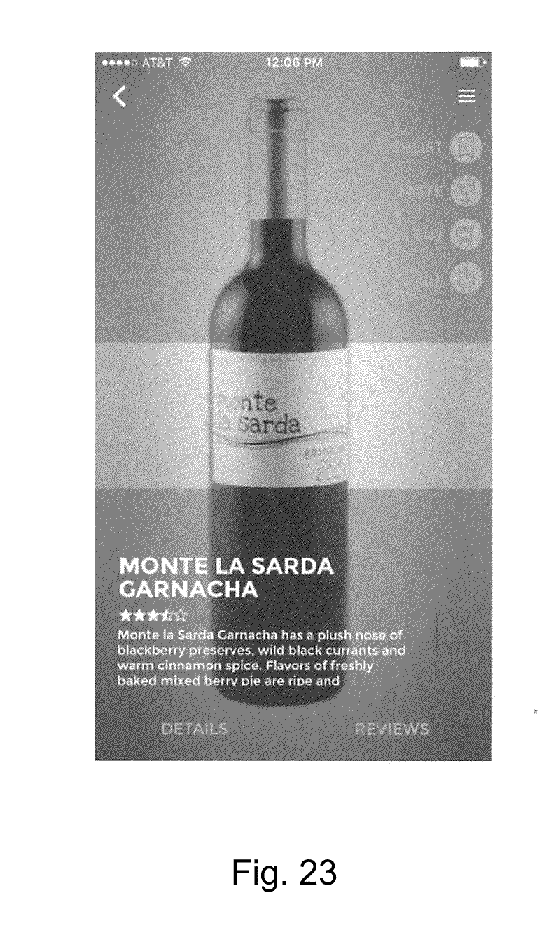

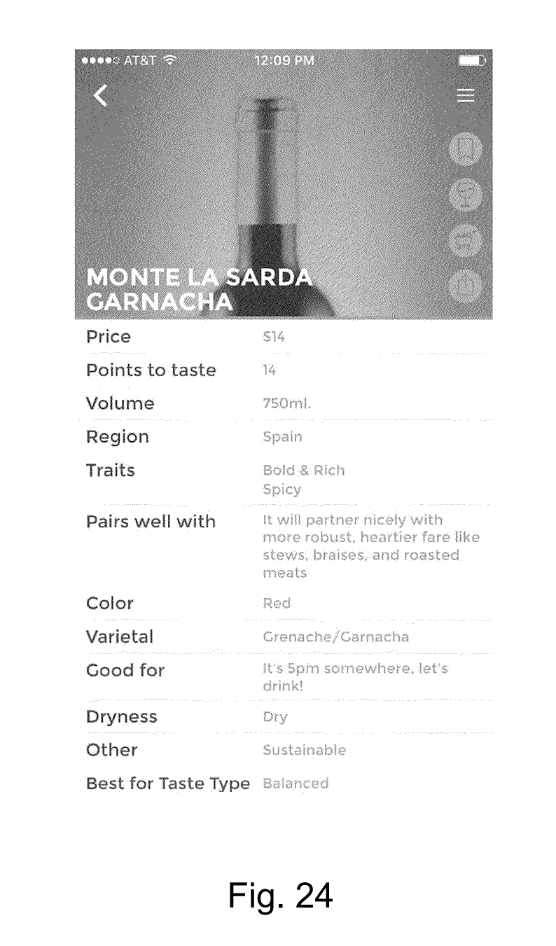

In viewing each recommended wine list (personal and popular), shown in FIG. 21, the app may show a thumbnail photo of the bottle, and for each bottle, the name of the wine, the type of wine, current rating (shown in number of stars), an icon for adding the wine to the shopping cart, and an information icon. The information icon may lead the user to a wine information screen, as shown in FIG. 23, which may give specific information about the selected wine, including but not limited to: a full or larger photo of the bottle, the wine rating (shown in number of starts) and a brief description thereof. From this screen, the user may have the option of adding the bottle to his or her wish list, beginning the taste or sampling process, adding the bottle to his or her cart, or sharing the bottle with a friend or connection via SMS text message, posting to Facebook, Instagram, Pinterest, Google+, or Twitter, or adding to his/her notes. Additionally, the user may view details of the selected wine by selecting the details icon. An example of the details page is shown in FIG. 24. The details include, but are not limited to: the cost of (1) one bottle; the number of points required to obtain a sample of said wine; the bottle volume; the style or traits (e.g., light & fruity, bold & rich); the region; compatible food pairings; the color; the varietal; the dryness; and the taste type best suited for.

In other embodiments, the wine recommendation lists (both personal and popular) may be filtered on additional or different set of criteria. The information displayed about each bottle of wine contained on either the personal or popular wine recommendation list may be organized differently, shown on different screens or may include more, less or different information.

### Tasting/Sampling Wine

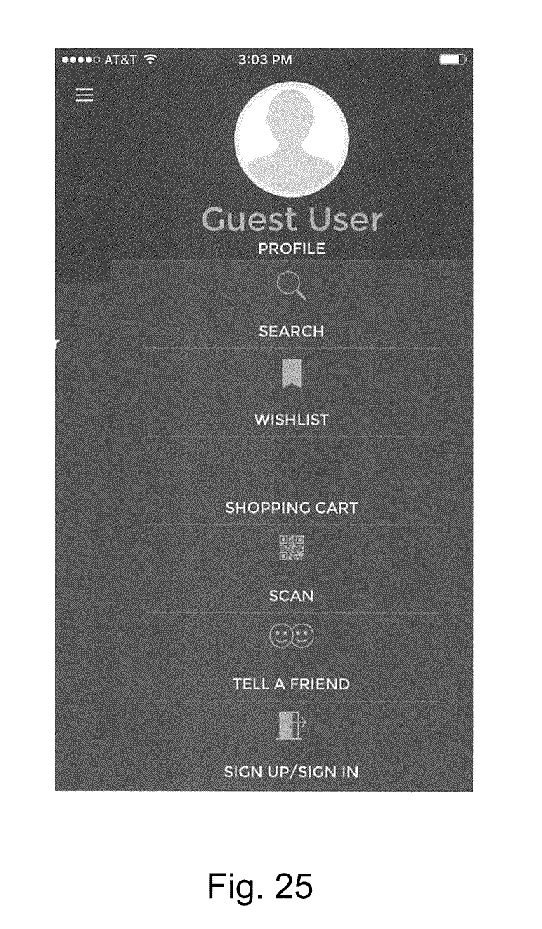

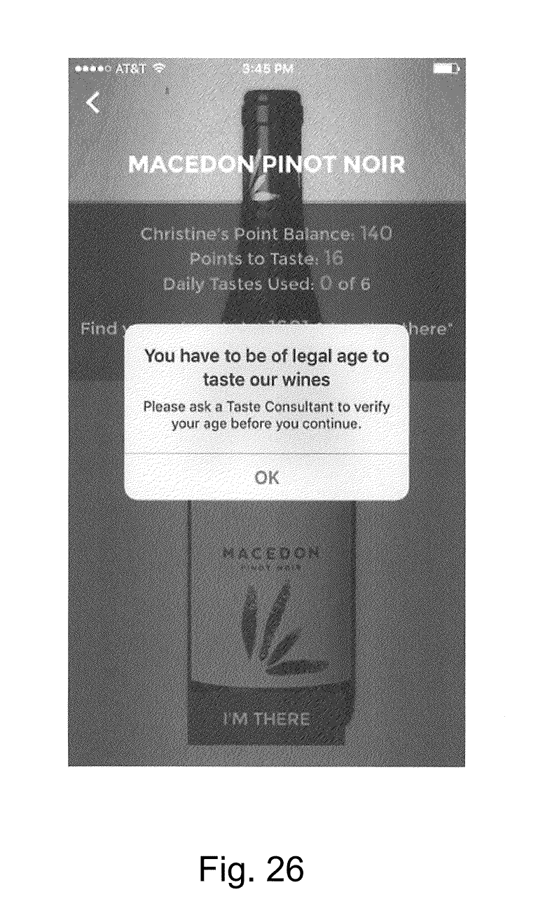

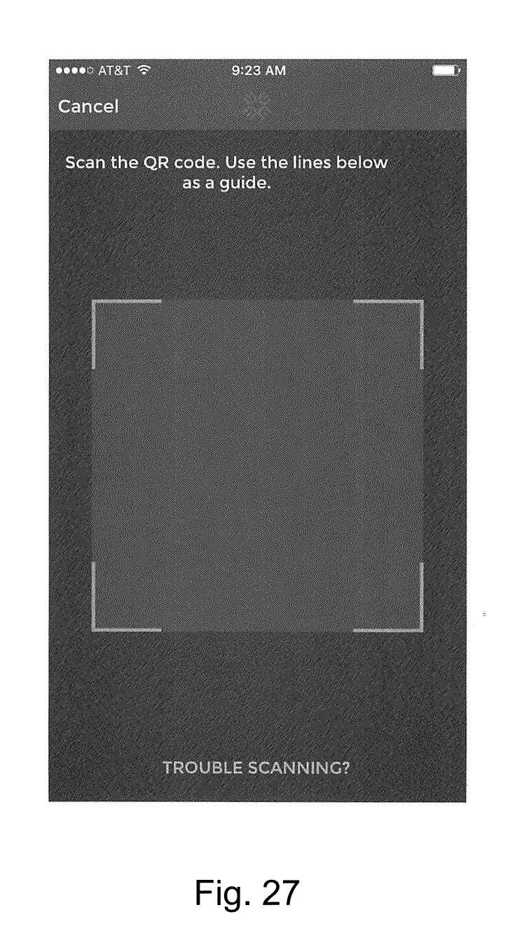

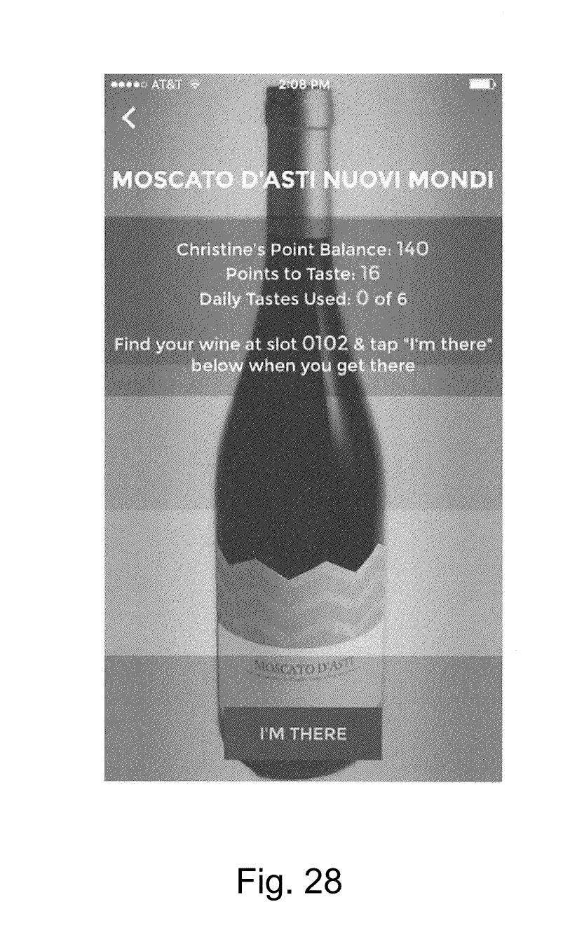

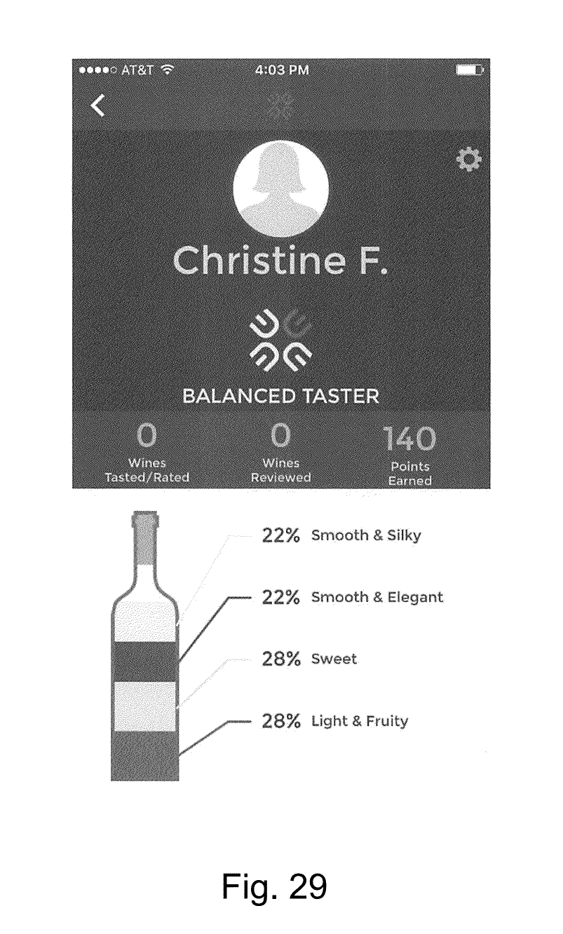

Tasting or sampling a particular bottle of wine can be accomplished directly from the app's main menu, as shown in FIG. 25 or through each detailed wine page accessed through the personal or popular wine recommendation list. Each wine available for sample may have a predetermined number of points assigned thereto. In order to sample a particular wine, the user must have accumulated points equal to or greater than the point value assigned to the selected wine. Users can view his or her total number of points by visiting the user profile screen within the mobile app, as shown in FIG. 26. Initiating the sampling process via the app's main menu may require the user to scan a machine-readable identifier contained on the wine dispenser containing the wine the user has selected for sampling. A sample screen for scanning the identifier is shown in FIG. 27. Initiating the sampling process via the detailed wine page may cause the app to display a screen which directs the user to the specific location within the retail store where the dispenser containing the selected wine is located, as shown in FIG. 28. Once the user makes his/her way to the indicated dispenser, he or she can indicate through the app that he or she has located the appropriate dispenser and then scan the identifier to unlock the wine dispenser and thereby dispensing the selected sample. Prior to dispensing the sample (and only the first time the user engages with the app), the app may display a message warning the user that he/she must be of legal age to sample wine, as shown in FIG. 29. The message may direct the user to ask a store consultant to verify his or her age prior to he or she obtaining the sample. Scanning the QR code may initiate the wine dispenser “unlock” process (discussed in further detail below) which may confirm that the user has accumulated enough points for the selected sample and may also confirm that the user has not used up his/her allotted samples for the current visit and if both are confirmed, the dispenser may be “unlocked”. Once “unlocked”, the user must push a press button located on the dispenser and the dispenser will automatically dispense the wine sample. The sample, in a preferred embodiment is approximately between ½ and 1 fluid ounce. Once the sample is dispensed, the user's account may be debited by the number of points required for the sample and the dispenser may return to the “locked” state.

### Mobile App Process Example

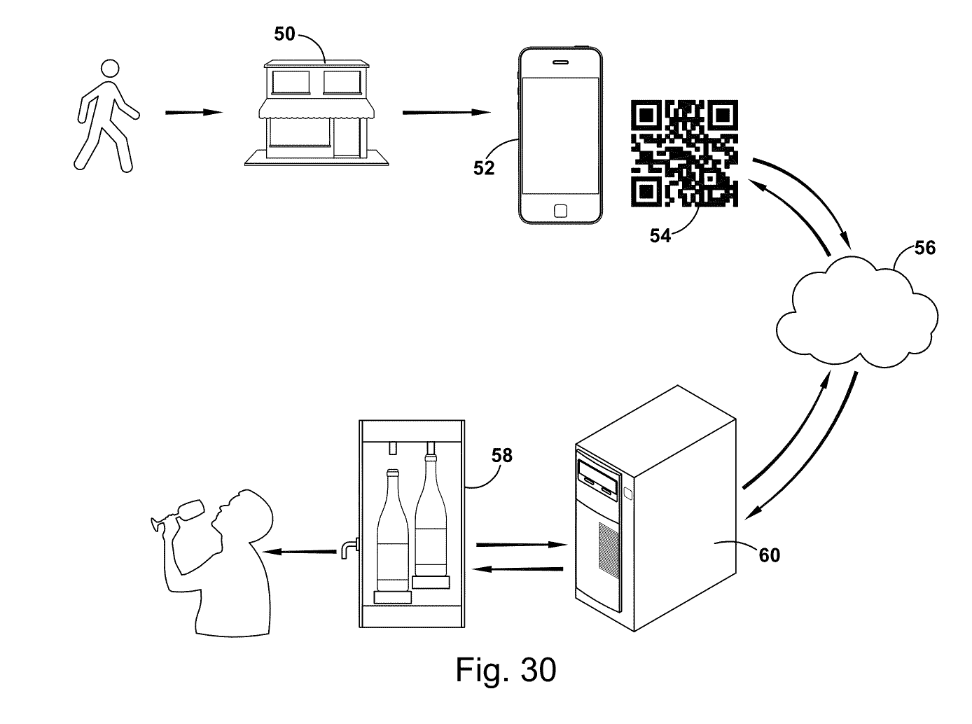

The following process is an example of a user experience from entering the retail store to sampling and/or purchasing one or more wine selections. A flow chart outlining an example of this process is shown in FIG. 30.

Upon entering the retail store the user may be encouraged to either download and/or open the proprietary mobile app on his or her mobile device 10. A returning visitor may have already downloaded the app or a new user may have downloaded the app prior to visiting the retail store. A user may sign in using a pre-existing social media account, such as Facebook or Google+. A user account may be set up via the mobile app by entering information such as, for example, name, gender, email address, password, birth date and phone number. The user can also select whether or not he/she wishes to receive future marketing materials via email. The user may be awarded a specific number of points, such as, for example 100 points, for creating a user account. In a preferred embodiment, a user account must be set up in order to determine a user's taste type and subsequently provide a list of recommended wines. However, users may bypass setting up a user account and establishing a user profile and login as a guest user 12. A guest user may only use the app to view and filter the popular wine recommendation list and learn about the various wines available for purchase 14. A guest user may also make a purchase 16.

As noted above, after signing in or signing up for a user account, the user may be provided the opportunity to take a taste test which may be input into an algorithm operative to determine the user's taste type 20. The user's taste type may determine the selection of wines represented in the user's personal wine recommendation list. The taste test, in a preferred embodiment, may include six (6) questions which may be directed to the users likes and dislikes. According to a preferred embodiment, the taste type can be any one of the following: sweet, hyper, balanced, or bold. However, in other embodiments, additional or other taste types may be included. If the user declines to take the taste test, he or she may only have access to a list of popular wine recommendation and may not be assigned a personal wine recommendation list 22. He or she can browse and filter the list 24 or proceed directly to tasting 26. The user may first browse the list 24 and then select a wine for sampling 28. After browsing the list and/or sampling one or more wines, the user can elect to make a purchase 30. The user's in-store experience ends when he or she leaves the store 32.

If the user has taken the taste test and therefore been assigned a taste type, the app may invite the user to answer an additional series of questions which may provide the algorithm with additional information which may allow it to further refine the user's wine recommendation list 34. In a preferred embodiment, the second series of questions may include eight (8) multiple choice questions in the form of “which do you prefer?” and may ask the user about his/her personal taste preferences food and drink items including, but not limited to: coffee; salty and spicy foods; chocolate; vegetables; fruit and wine. In other embodiments, the number of questions may be five (5) or less, six (6), seven (7), nine (9), or ten (10) or greater and may be directed to different food and drink preferences. These questions are intended to further refine the user's taste type and more closely predict a selection of wines which the user may find enjoyable. This series of questions, as with the taste test questions, may be entirely optional and can be bypassed within the app.

Once a user has been assigned a taste type, a personal wine recommendation list may be created based on the user's taste type 36. The user can proceed by either browsing and filtering 32 his or her personal wine recommendation list (and/or popular wine recommendation list) or he or she may proceed directly to tasting 40. The user's personal wine recommendation list may include wines which are compatible with the user's taste type and which the user may be more likely to enjoy. The app may also provide users with a recommendation list based on popular wines. Users who have been assigned a taste type may have access to both a personal and the popular wine recommendation lists. Users who do not receive a taste type (because they did not sign up for an account and/or did not answer the taste questions posed by the app) may have access to the popular wine recommendation list only. The popular wine recommendation list may be composed based on store sales, user ratings and/or reviews, overall industry trends, or other such criteria. Each wine list (personal or popular) may give the user the option to filter the list based on various features. In a preferred embodiment, these features may include, but are not limited to: cost (less than $15, between $15-$25, between $25-$50, or greater than $50); dryness (any dryness, dry or sweet); color (red, rose or white); traits (various based on color); varietal (various); or user ratings (two (2) or more stars, three (3) or more stars, four (4) or more stars, or five (5) or more stars). Other potential filtering options may include, but are not limited to: vintage (year of harvest); country of origin; food options the wine may pair well with; and number of ratings or reviews. The wine traits can be filtered based on the color of the wine. For example, for red wine, the traits may include, but are not limited to: sweet, light & fruity, bold & rich, smooth & elegant, and spicy. For rose, the traits may include, but are not limited to: bubbly. And for white wine, the traits may include, but are not limited to: sweet, smooth & silky, rich & creamy; and tart and fresh. Similarly, the varietals can also be filtered based on the color of the wine.

In viewing each recommended wine list (personal and popular), the app may show a thumbnail photo of the bottle, and for each bottle, the current rating (shown in number of stars), an icon for adding the wine to the shopping cart, and an information icon. The information icon may lead the user to a wine information screen which may give specific information about the selected wine, including but not limited to: a full photo of the bottle, the wine rating (shown in number of starts) and a brief description thereof. From this screen, the user may have the option of adding the bottle to his/her wish list, beginning the taste or sampling process, adding the bottle to his/her cart, or sharing the bottle with a friend or connection via SMS text message, posting to Facebook, Instagram, Pinterest, Google+, or Twitter, or adding to his/her notes. Additionally, the user may view details of the selected wine by selecting the details icon. The details include, but are not limited to: the cost of (1) one bottle; the number of points required to obtain a sample of said wine; the bottle volume; the style or traits (e.g., light & fruity, bold & rich); the region; compatible food pairings; the color; the varietal; the dryness; and the taste type best suited for.

After browsing the user's recommended wine list (and/or the popular wine recommendation list) 38, he or she may elect to sample one or more wines 40. Either before or after tasting the user may elect to make a purchase 42. The user's in-store experience ends when he or she leaves the store 44.

Once the user has tasted up to his or her maximum number of wine samples or any time before reaching that limit, he or she may either purchase one or more bottles of wine or end the in-store experience. Purchases can be made directly through the mobile app or at an in-store kiosk or at a store employee operated point-of-sale register.

### System Components

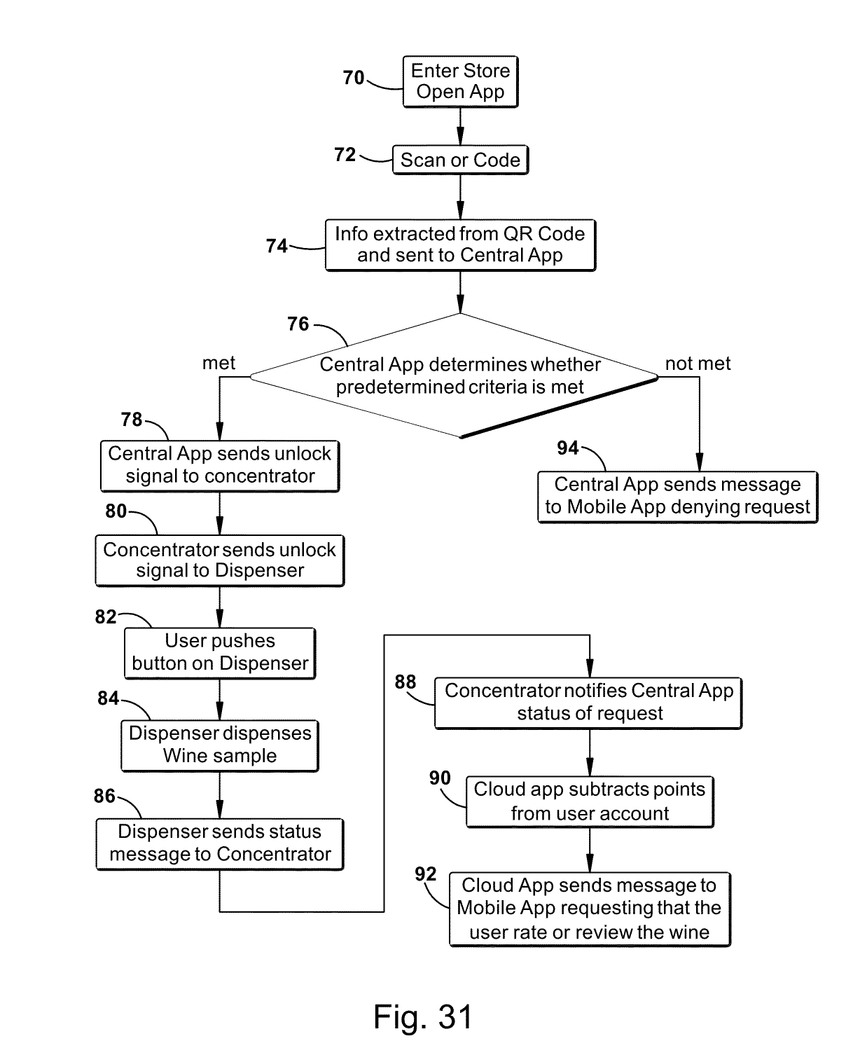

In a preferred embodiment, the system of the present technology may include, but is not limited to: a retail store 50, a mobile device with mobile app downloaded thereon 52, one (1) or more servers, physical or virtual comprised of memory, a central processing unit (CPU), a network interface and one or more storage devices, a network, either physical, wireless or a combination thereof, comprising one or more routers, switches, firewalls, and other network appliances; a central application 56; an Application Programming Interface (API); a concentrator 60; and plurality of wine dispensers 58. The servers and the network may be implemented as Infrastructure-as-a-Service, Platform-as-a-Service, Software-as-a-Service or any other form of hosted computing. A flow chart showing the data flow between system components is shown in FIG. 31.

### Central Application

The central application 56 may execute business logic and algorithms and store and manage data items including, but not limited to: user identity and account information; user taste profile including assigned taste type; user point balance; user wish list; user shopping cart; user transaction history; and wine dispenser location, contents and assigned point values. In a preferred embodiment, the central application 56 sends information to and receives information from the mobile app 52, via API, and receives information from and sends information to the concentrator 60, via web sockets. The central application 56 may reside locally or at a remote internet-accessible location. In a preferred embodiment, the central application 56 is cloud-based.

Concentrator In a preferred embodiment, the concentrator 60 may be an in-store computer server which may be responsible for sending information to and receiving information from the central application 56 and the plurality of in-store wine dispensers 58. In other embodiments, the concentrator 60 may be a remote server or servers.

### Wine Dispensers

Each of the plurality of wine dispensers 58 may accommodate the automated dispensing of wine via the mobile app 52. The dispensers may contain a control application which may be operative to control the electronic components, electro-valves and Liquid Crystal Display (LCD) screen of each dispenser 58. In a preferred embodiment, control of the value poured may be achieved using calculations based on a constant flow rate during a specified amount of time.

Alternatively, a direct measurement of liquid may be used. Each dispenser 58 may contain two different boards that communicate with each other—a control board and an LCD board. The control board may use Transmission Control Protocol (TCP) to communication with the concentrator 60 through a network interface. The control board may communicate with the LCD board to send data to be shown on each dispenser's LCD screen. Communication with electrical and mechanical components allow the wine to be dispensed. The LCD board may communicate with the control board to receive temperature and information related to the status of the dispenser 58. The LCD board may also communicate with an LCD panel to present information on the screen.

### Technical Process (For Requesting and Dispensing Wine Samples)

A chart showing an example of the technical process involved in requesting and dispensing wine samples is shown in FIG. 32. Beginning at 70, a user enters the retail store and opens the mobile app on his or her mobile device (or alternatively uses a mobile device with downloaded app provided in-store). The user can use one of the processes outlined above to select a wine to which to sample (or randomly select). At 72, the user uses his or her mobile device (or a mobile device provided in-store) to scan a QR code contained on the dispenser containing the wine that the user is interested in sampling. At 74, the information from the QR code may be extracted by the mobile device and sent to the central application. In a preferred embodiment, the QR code may contain an alphanumeric code which may correspond to a particular dispenser and a specific store location. The central application receives the information from the mobile app and cross-references the information (dispenser and store location) to determine the specific wine which is contained within the specified dispenser in the specified retail store. At 76, once the specific wine is determined, the central application may obtain the number of points required for sampling the specified wine and determine whether the total number of points in the user's account is greater than or equal to the number of points required for the sample. The central application may also determine whether the user has used his or her maximum number of daily tastes (users are limited to six (6) daily samples in a preferred embodiment). At 78, if the user has accumulated enough points for the sample and is under his or her daily sample limit, then the central application sends a message or signal, via web sockets (or other communication protocol), to the concentrator (concentrator is responsible for sending and receiving information from dispensers). Each of the plurality of in-store wine dispensers may be in a locked position until they are unlocked via a message or signal from the concentrator. At 80, the concentrator sends an unlock signal, using TCP (or other communication protocol), to the specified dispenser. At 82, the user pushes the button located on the dispenser and at 84, the wine sample is dispensed from the dispenser. When the press button is pushed on an unlocked dispenser, the dispenser may send a digital signal to activate internal electro-valves within the dispenser in the following sequence: 1.) allow the argon to flow into the bottle to push the wine out; 2.) opens a specific value to let the wine flow; 3.) waits a predetermined time period depending on the amount of wine poured; and 4.) closes the valve. At 86, the dispenser sends a response to the concentrator that informs (via a display screen) store personnel of the status of each dispenser. At 88, the concentrator notifies the central application of the status of the request using web sockets (or other communication protocol). At 90, the central application debits the number of points required for the dispensed sample from the user's account and at 92, the central application sends a push message to the mobile app notifying the user of the status of his or her request and suggests that the user rate and review the wine. Alternately, at 94, if the user does not have enough points for the sample and/or if he or she has already reached his or her daily sample limit, the central application sends a message back to the mobile app notifying the user that the request has failed. Pushing the button on a locked dispenser may have no effect.

In an alternate embodiment, the dispensers may communicate directly with the central application thereby eliminating the need for the concentrator or other server.

Although the present disclosure and related technologies are described herein and shown in the figures with respect to a preferred embodiment, one having skill in the art is aware that modifications can be made while still remaining within the scope of the claimed invention. The foregoing embodiments of the present technology have been presented for the purposes of illustration and description. These descriptions and embodiments are not intended to be exhaustive or to limit the claimed invention to the precise form disclosed, and obviously many modifications and variations are possible in light of the above disclosure. The embodiments were chosen and described in order to best explain the principle of the disclosed technology and its practical applications to thereby enable others skilled in the art to best utilize the disclosed technology in its various embodiments and with various modifications as are suited to the particular use contemplated. It is intended that the invention be defined by the following claims.

1. A method, comprising:
receiving from a mobile device, a request for a sample of an unspecified wine from among a plurality of wines stored in a plurality of wine dispensers, each of said wine dispensers containing at least one wine selection;
responsive to the request, determining by a processor a specific wine, said determining based at least on data accessible by the processor; and
responsive to the request and the determining, dispensing a sample of the specific wine.

2. The method of claim 1, wherein the mobile device requests a sample by scanning a machine readable identifier.

3. The method of claim 2, wherein the machine readable identifier is a QR code.

4. The method of claim 1, wherein the request includes information which uniquely identifies a particular wine dispenser from the plurality of wine dispensers.

5. The method of claim 1, wherein the request includes information which uniquely identifies a retail location wherein the plurality of wine dispensers reside.

6. The method of claim 1 further comprising the step of downloading a mobile app to the mobile device, the mobile app operative to communicate, either directly or indirectly, with the plurality of wine dispensers.

7. The method of claim 4, wherein the specific wine is determined based on the unique identity of the wine dispenser.

8. A system for providing wine samples, comprising:
a retail establishment having a plurality of automated wine dispensers contained therein, each of the plurality of wine dispensers having at least one wine selection contained therein;
a mobile app stored on a mobile device, the mobile app operative to initiate a request to receive a sample of an unspecified wine from one of the plurality of automated wine dispensers; and
a processor operative to determine, in response to the request, a specific wine, based at least on data accessible by the processor.

9. The system of claim 8, wherein each of the plurality of wine dispensers contains a machine readable code thereon which uniquely identifies the wine dispenser.

10. The system of claim 9, wherein the machine readable code also uniquely identifies the retail establishment.

11. The system of claim 9, wherein the mobile app initiates the request to receive a sample by scanning the machine readable code contained on one of the plurality of wine dispensers.

12. The system of claim 8, wherein the mobile app is operative to communicate, either directly or indirectly, with the plurality of wine dispensers.

13. The system of claim 9, wherein the specific wine is determined based on the information uniquely identifying the wine dispensers.

14. The system of claim 8, wherein the processor determines a specific wine based on the one of the plurality of wine dispensers.

15. A method for creating a wine recommendation list, comprising:
receiving a scan or photo of at least a portion of a human tongue;
analyzing the scan or photo to determine the number of taste buds within a predetermined area of the human tongue; and
determining at least one wine recommendation based at least on the density of taste buds within the predetermined area.

16. The method of claim 15 further comprising the step of receiving from a mobile device, a request for a sample of the at least one wine recommendation from one of a plurality of wine dispensers.

17. The method of claim 15 further comprising the step of receiving from a mobile device a request for a sample of an unspecified wine from one of the plurality of wine dispensers.

18. The method of claim 17 further comprising the step of determining, using a processor, in response to the request, a specific wine based on the at least one wine recommendation.

19. The method of claim 15, wherein the scan or photo is received from a mobile device.

20. The method of claim 15, wherein the scan or photo is received by upload through a web browser.
